(19) United States
(12) Patent Application Publication
(10) Pub. No.: US 2006/0036706 A1
(43) Pub. Date: Feb. 16, 2006

(54) Supplementary information dissemination system

(75) Inventor: Hiroshi Sakamoto, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/707,013

(22) Filed: Nov. 14, 2003

(51) Int. Cl. G06F 15/16

(52) U.S. Cl. 709/217; 709/203

(57) ABSTRACT

A supplemental information dissemination system is disclosed which provides supplemental information on managed documents having unique identifying information printed thereon, and is comprised of a supplemental information management server and a supplemental information acquisition device. The supplemental information management server stores supplemental information on each document that has identifying information associated with each document. The supplemental information acquisition device reads identifying information on a document, and acquires stored supplemental information on the document associated with the identifying information from the supplemental information management server.

### BACKGROUND OF INVENTION

1. Field of the Invention

The present invention relates to a supplementary information dissemination system that provides supplementary information on documents via a network, and more particularly relates to a supplementary information dissemination system that can provide supplementary information such as update information, use history information, expiration date information, error information, up-to-date citation information, link information, and the like for documents, specifications, drawings, process documents, application forms, certificates, advertisements, catalogs, price lists, name lists, telephone books, address books, technical documents, publications, and the like that are printed on a printing medium such as paper.

2. Background Information

There have been recent proposals to encode unique identifying information allocated to a document on the document itself at the same time the document is printed (see for example Japanese Utility Model Registration No. 3045248 and Japanese Published Patent Application No. 2000-148742).

For example, with the image forming device disclosed in Japanese Utility Model Registration No. 3045248, when a document that has already been printed once is to be reprinted, the contents of the document will be printed in accordance with document print data saved in the image forming device if the identifying information for the document is read with a bar code reader provided in the image forming device.

In addition, with the authentication management system disclosed in Japanese Published Patent Application No. 2000-148742, when a user wants to confirm the authenticity of a certificate that accompanies a document, the authentication management system will inform the user whether or not the certificate is authentic based upon stored authentication data when the identifying information on the document is read with a bar code reader.

However, in most real life situations, one will more likely want to know if the contents of the documents are correct and/or still valid, and not whether or not a certificate that accompanies a document is authentic.

For example, documents such as specifications and drawings produced by a manufacturer when new products are developed will be frequently updated, and thus one who references these documents will want to know whether or not the documents being referenced are the most up-to-date versions thereof. Normally, old specifications and drawings will be periodically updated and published as new versions or editions thereof. However, there is a possibility that one may inadvertently reference copies of old specifications and drawings and not know that newer versions or editions of these documents exist.

In addition, because documents such as application forms and the like are updated in response to need, one may wonder whether or not the application form they are using is the most up-to-date version thereof. For example, one may be forced to resubmit an application because one used an old version of the application form.

It is possible to avoid the problems caused by these old documents if the validity of the documents could be confirmed when one references and/or uses them. However, many mistakes and losses occur due to one referencing and/or using old documents because there is no simple method of confirming the validity of documents in the prior art.

In view of the above, there exists a need for a supplementary information dissemination system which overcomes the above mentioned problems in the prior art. This invention addresses this need in the prior art as well as other needs, which will become apparent to those skilled in the art from this disclosure.

### SUMMARY OF INVENTION

It is an object of the present invention to provide a supplementary information dissemination system that can enable one to simply confirm the validity of documents when they are referenced and/or used, and as a result thereof, prevent mistakes or losses caused when old documents are referenced and/or used, by making it possible to easily acquire supplemental information on documents that is updated in response to changes made to the documents.

A supplemental information dissemination system according to a first aspect of the present invention provides supplemental information on managed documents having unique identifying information printed thereon, and is comprised of a supplemental information management server and a supplemental information acquisition device. The supplemental information management server stores supplemental information on each document that has identifying information associated with each document. The supplemental information acquisition device reads identifying information on a document, and acquires stored supplemental information on the document associated with the identifying information from the supplemental information management server.

If the supplemental information dissemination system is configured in this way, a person who references and/or uses a document can easily acquire supplemental information that is updated in response to changes in the document by employing the supplemental information acquisition device.

For example, if supplemental information such as “This document has been updated. Please read the second edition” is registered in the supplemental information management server when a document is updated, persons in possession of old versions of that document can be informed of the existence of the latest version thereof.

This allows one to easily confirm the validity of a document when referencing and/or using the same, and as a result, mistakes and losses caused by one referencing and/or using old versions of documents can be prevented.

In another aspect of the present invention, it is preferable that the supplemental information management server and the supplemental information acquisition device are connected to each other via a network.

In yet another aspect of the present invention, it is preferable that this system further comprise a print device that both prints documents and prints encoded identifying information on the documents.

In yet another aspect of the present invention, the supplemental information management server of the supplemental information dissemination system of the present invention will, when the contents of a managed document has been updated, both allocate new identifying information to the updated document, and request or allow updates to stored supplemental information associated with pre-update identifying information.

If the supplemental information dissemination system is configured in this way, the reliability of the supplemental information can be improved because the supplemental information on a document will be updated when the document is updated.

In yet another aspect of the present invention, the supplemental information management server of the supplemental information dissemination system of the present invention will, when the contents of a managed document has been updated, both allocate new identifying information to the updated document, and automatically update stored supplemental information associated with pre-update identifying information.

If the supplemental information dissemination system is configured in this way, not only will the task of updating the supplemental information be eliminated, but supplemental information on old versions of a document will be updated when the document is updated.

In yet another aspect of the present invention, the supplemental information management server of the supplemental information dissemination system of the present invention will request or allow updates to stored supplemental information associated with identifying information when a managed document is deleted.

If the supplemental information dissemination system is configured in this way, the reliability of the supplemental information can be improved because the supplemental information for a deleted document will be updated when the document is deleted.

In yet another aspect of the present invention, the supplemental information management server of the supplemental information dissemination system of the present invention will automatically update stored supplemental information associated with identifying information when a managed document is deleted.

If the supplemental information dissemination system is configured in this way, not only will the task of updating the supplemental information be eliminated, but supplemental information on a deleted document will be updated when the document is deleted.

In yet another aspect of the present invention, a printer device of the supplemental information dissemination system of the present invention will print encoded identifying information allocated to a document, an encoded network address of the supplementary information management server, and encoded information on the location of the supplementary information on the document.

If the supplemental information dissemination system is configured in this way, it will not be necessary to input the network address of the supplemental information management server each time supplemental information is to be acquired, and as result, supplemental information on documents can be rapidly acquired because both identifying information for the documents and the network address of the supplemental information management server can be read from the documents.

In yet another aspect of the present invention, the printing device of the supplemental information dissemination system of the present invention will print identifying information for a document as a bar code.

If the supplemental information dissemination system is configured in this way, the cost of the supplemental information acquisition device can be controlled because a widely available bar code reader can be employed to read the identifying information.

In yet another aspect of the present invention, the supplemental information acquisition device of the supplemental information dissemination system of the present invention comprises a reading unit that reads identifying information, and a display unit that presents supplemental information acquired from the supplemental information management server to a user as text or sounds.

If the supplemental information dissemination system is configured in this way, identifying information for documents can be read from the documents, and supplemental information on documents can be referenced by a user at the location at which the identifying information is read.

In yet another aspect of the present invention, the supplemental information acquisition device of the supplemental information dissemination system of the present invention is a bar code reader comprised of a wireless communication module.

If the supplemental information dissemination system is configured in this way, the supplemental information acquisition device can be carried to various locations in order to acquire supplemental information on documents.

In yet another aspect of the present invention, the supplemental information acquisition device of the supplemental information dissemination system of the present invention is a copying machine comprised of a network interface and a scanner, and extracts encoded identifying information from document image data read by the scanner.

If the supplemental information dissemination system is configured in this way, the copying machine can be used to acquire supplemental information for documents. In addition, if the supplemental information dissemination system is configured such that the supplemental information is automatically confirmed when documents are copied, one can be prevented from making copies of old versions of documents.

In yet another aspect of the present invention, the supplemental information acquisition device of the supplemental information dissemination system of the present invention is a portable telephone having a camera, and extracts encoded identifying information from document image data photographed by the camera.

If the supplemental information dissemination system is configured in this way, a portable telephone can not only be used to acquire supplemental information on documents, but the portability of the camera can be utilized to acquire supplemental information on documents at a variety of locations.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF DRAWINGS

Referring now to the attached drawings which form a part of this original disclosure:

FIG. 1 is block diagram illustrating the configuration of a supplementary information dissemination system according to a first embodiment of the present invention;

FIG. 2 illustrates the configuration and use of the supplementary information dissemination system according to the first embodiment;

FIG. 3 is block diagram illustrating the functional configuration of a document management server according to the first embodiment;

FIG. 4 is a flowchart illustrating the process sequence of document management terminal software according to the first embodiment;

FIG. 5 illustrates a new registration operation display screen according to the first embodiment;

FIG. 6 illustrates a new registration confirmation display screen according to the first embodiment;

FIG. 7 illustrates an update operation display screen according to the first embodiment.

FIG. 8 illustrates an update confirmation display screen according to the first embodiment;

FIG. 9 illustrates a delete operation display screen according to the first embodiment;

FIG. 10 illustrates a delete confirmation display screen according to the first embodiment;

FIG. 11 illustrates a print operation display screen according to the first embodiment;

FIG. 12 illustrates a print details display screen (layout) according to the first embodiment;

FIG. 13 illustrates a print details display screen (barcode) according to the first embodiment;

FIG. 14 illustrates the details of a barcode print setting according to the first embodiment;

FIG. 15 illustrates a lateral view and a front view of a bar code reader according to the first embodiment;

FIG. 16 is block diagram illustrating the configuration of a bar code reader according to the first embodiment;

FIG. 17 illustrates the configuration and use of a document management system according to a second embodiment of the present invention;

FIG. 18 is block diagram illustrating the configuration of a copying machine according to the second embodiment;

FIG. 19 illustrates the configuration and use of a document management system according to a third embodiment of the present invention; and

FIG. 20 is block diagram illustrating the configuration of a portable telephone according to the third embodiment.

### DETAILED DESCRIPTION

Preferred embodiments of the present invention will be described below with reference to the figures.

### 1. First Embodiment

First, a summary of the present invention will be described based upon the configuration of a first embodiment.

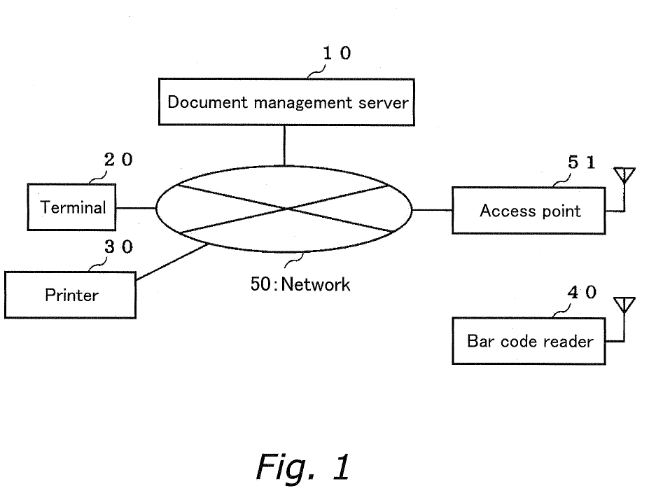

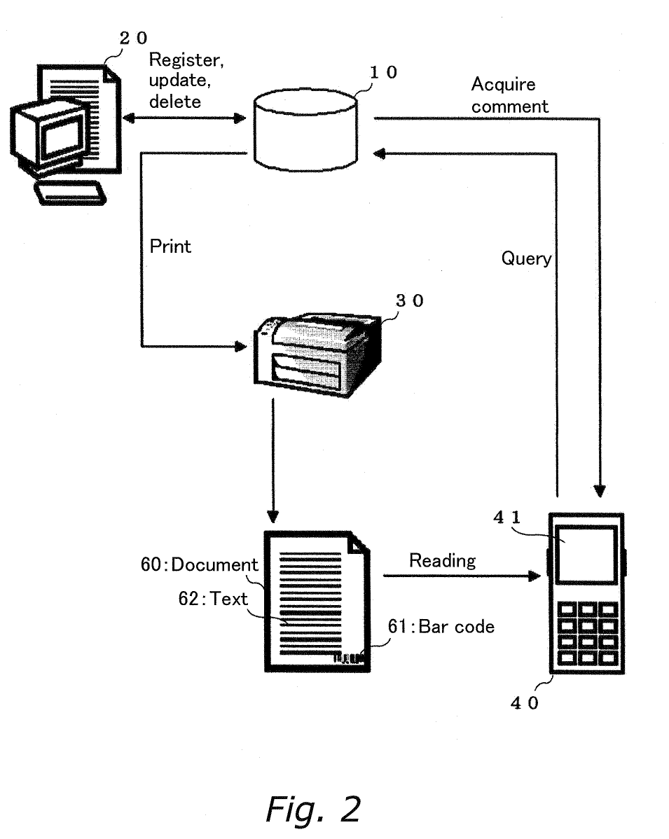

FIG. 1 is a block diagram showing a supplementary information dissemination system according to the first embodiment of the present invention, and FIG. 2 describes the configuration and the use of the supplementary information dissemination system according to the first embodiment.

As shown in these figures, a document management system of the first embodiment in which the supplemental information dissemination system of the present invention is implemented is comprised of a document management server (supplemental information management server) 10, a terminal 20, a printer 30, a bar code reader (a supplemental information acquisition device) 40 and a network 50.

The terminal 20 is connected to the document management server 10 via the network 50, and registers, updates, and deletes document files on the document management server 10. When the document management server 10 registers a new document file, it allocates a unique registration number (identification information) to the document file, associates the registration number with the document file, and saves the document file. A suffix that indicates the number of times the document has been updated is affixed to the end of the registration number, and the suffix of the registration number is updated when the registered document file is updated.

Supplemental information such as a comment or the like can be registered when a document file is newly registered or updated, and a comment accompanying an old version of a document file can be changed when the old version is updated or deleted. Supplementary information for a document file is associated with the registration number of the document file and stored in the document management server 10.

When a document 60 is to be printed, the terminal 20 accesses the document management server 10, the document file corresponding to a registration number is called up, and the document file is converted to print data with the printer driver of the terminal 20 and printed by the printer 30. Here, the registration number and a document management server address are printed as a bar code 61 on a predetermined location of the document 60.

Later on, when the validity of the document 60 is to be confirmed, a bar code reader 40 will be employed to read the bar code 61 on the document 60. The bar code reader 40 is connected to the network 50 via an access point 51 of a wireless LAN. The document management server 10 searches for the registration number that was received from the bar code reader 40, returns any comment that was associated and stored with the registration number, and sends the comment to the bar code reader 40. The contents of the comment is displayed on a display unit 41 of the bar code reader 40. For example, if a comment such as This file has been updated. Please refer to the second edition is displayed, it can be confirmed that the document 60 is not the latest version thereof.

Details of the first embodiment of the present invention will be described below with reference to the figures.

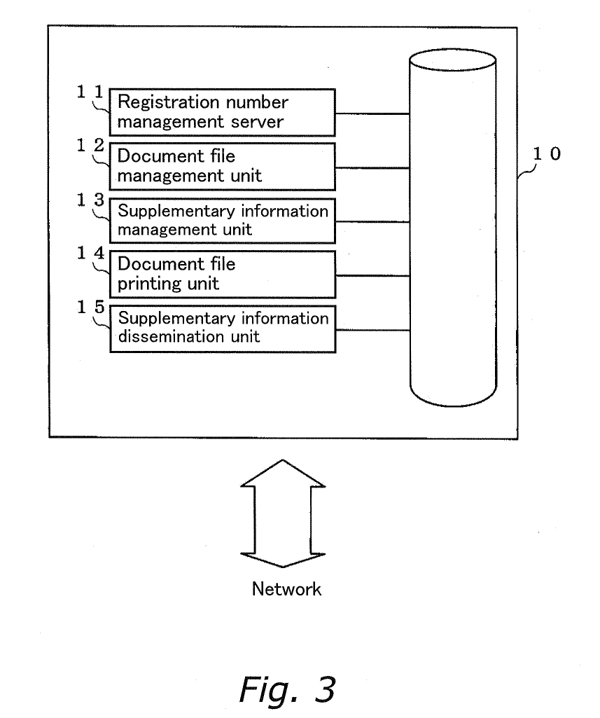

FIG. 3 is block diagram illustrating the functional configuration of the document management server according to the first embodiment.

The document management server 10 is a server computer that is comprised of hardware such as a CPU, ROM, RAM, a hard disk, a network interface, and the like. By installing document management server software in the document management server 10, the document management server 10 will be comprised of a registration number management unit 11 that allocates a unique registration number to each document file, a document file management unit 12 that stores document files that have registration numbers associated therewith, a supplemental information management unit 13 that stores supplemental information on the document files that have registration numbers associated therewith, a document file printing unit 14 that sends document files and supplementary information to the printer driver of the terminal 20, and a supplemental information dissemination unit 15 that provides supplemental information in response to queries from the bar code reader 40.

The terminal 20 is a personal computer that is comprised of hardware such as a CPU, ROM, RAM, a hard disk, a network interface, and the like. By installing document management terminal software and a printer driver in the terminal 20, the terminal 20 will be able to register document files in the document management server 10 and print document files with the printer 30.

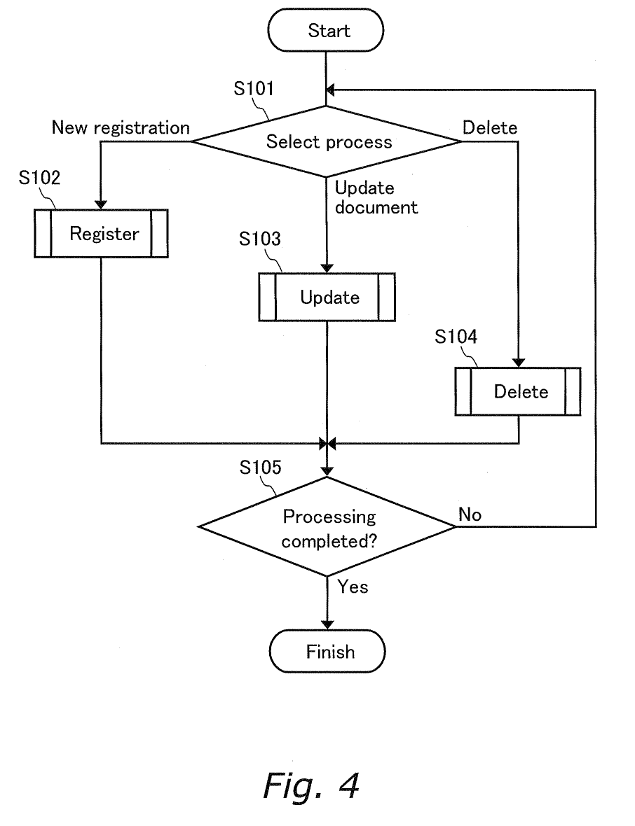

FIG. 4 is a flowchart illustrating the process sequence of the document management terminal software according to the first embodiment.

As shown in this figure, the terminal software installed in the terminal 20 is configured such that the software executes a new registration process (S102), an update process (S103), and a delete process (S104) in response to a process selection operation (S101) in the terminal 20, and ends each process in response to a process completion operation (S105).

The new registration process, update process, and delete process of the document management terminal software will be described below with reference to a display screen of the terminal 20.

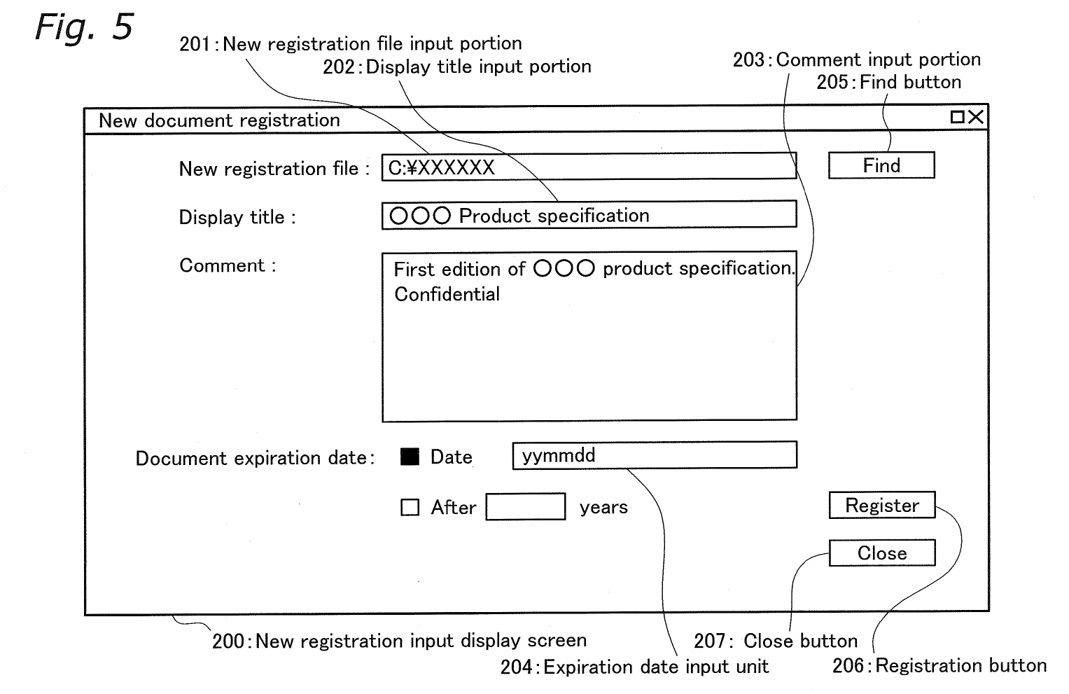

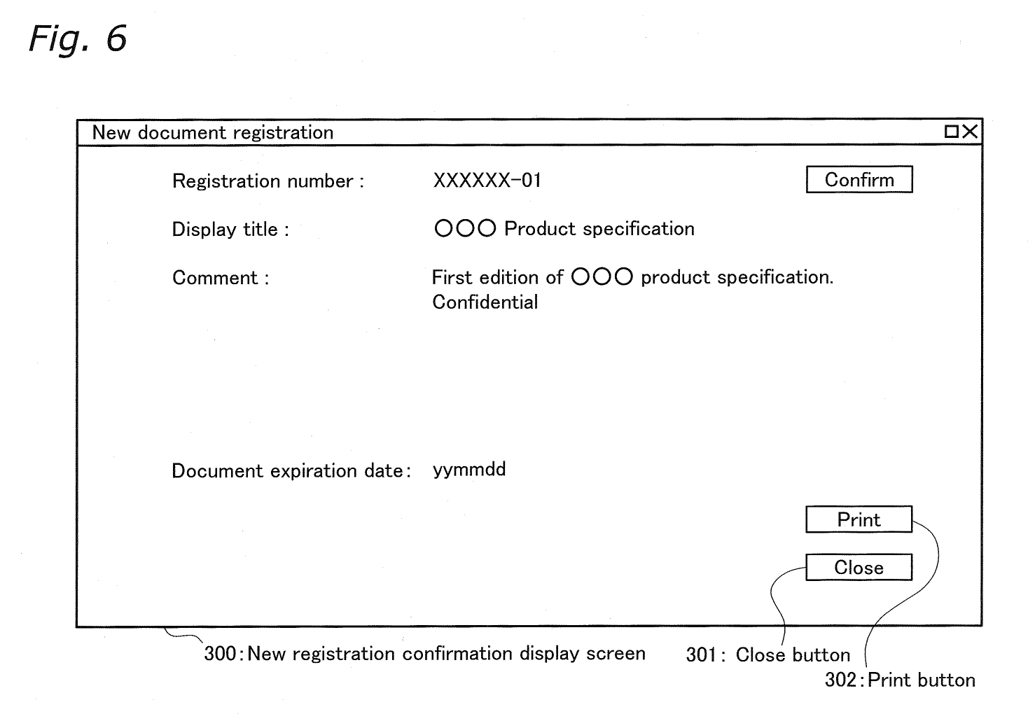

FIG. 5 illustrates a new registration operation display screen of the terminal 20 according to the first embodiment, and FIG. 6 illustrates a new registration confirmation display screen of the terminal 20 according to the first embodiment.

As shown in FIG. 5, a new registration input display screen 200 is comprised of a new registration file input portion 201, a display title input portion 202, a comment input portion 203, a expiration date input unit 204, a find button 205, a registration button 206, and a close button 207.

The source of a document file to be registered that is stored somewhere on the terminal 20 is designated and input into the new registration file input portion 201.

Here, one can browse the drive of the terminal 20 by clicking the find button 205.

The title to be attached to the document file for management purposes is input in the display title input portion 202. It is preferable that the title be easy to understand and different from that of another document file.

Comments relating to a document file are input in the comment input portion 203. Here, the comments that are input will be displayed by the bar code reader 40.

In situations in which there is a expiration date for the document file, this expiration date will be established by designating a date and inputting this date into the expiration date input portion 204. This expiration date data is saved in the document management server 10 as supplemental information, and when there is a query from the bar code reader 40, a comment such as Expiration date has expired will be transmitted to the bar code reader 40 if the expiration date for the document has expired.

When one clicks the registration button 206, the document file and the supplemental information will be sent to the document management server 10. Then, the document management server 10 will generate a registration number for the new document file that includes a suffix “-01”. This registration number is displayed on the new registration confirmation display screen 300 shown in FIG. 6 together with the data that was input. Then, if the process is completed with this display screen, the will be clicked, and if printing is to occur, the print button 302 will be clicked. Printing will be described in further detail below.

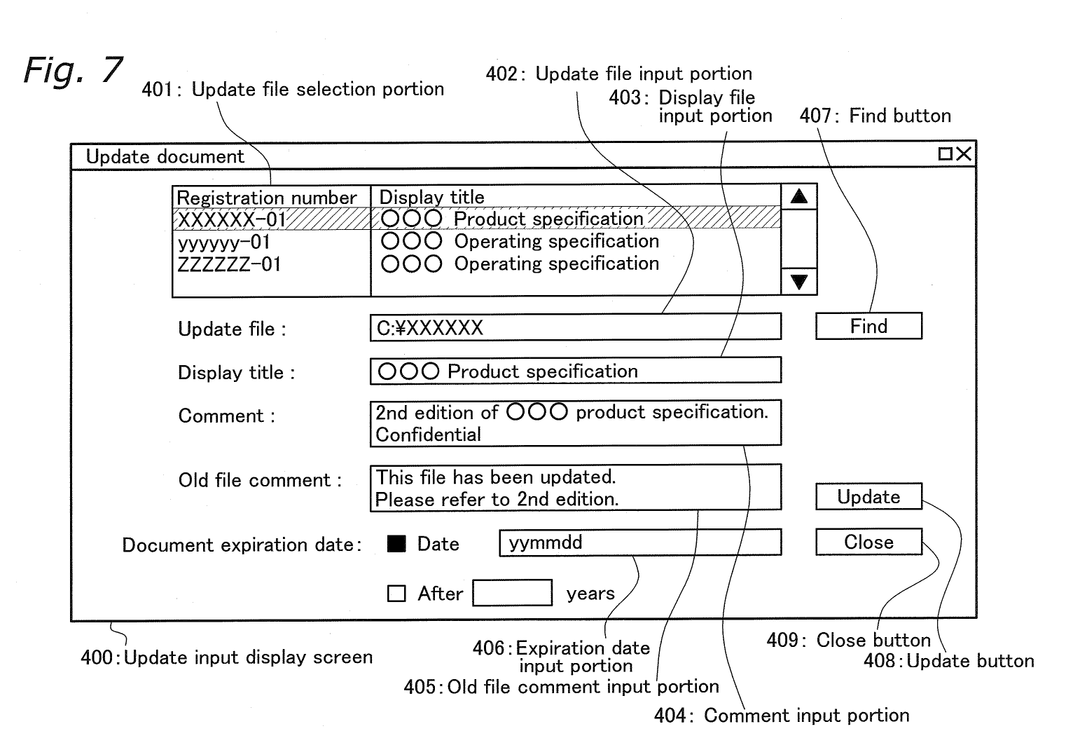

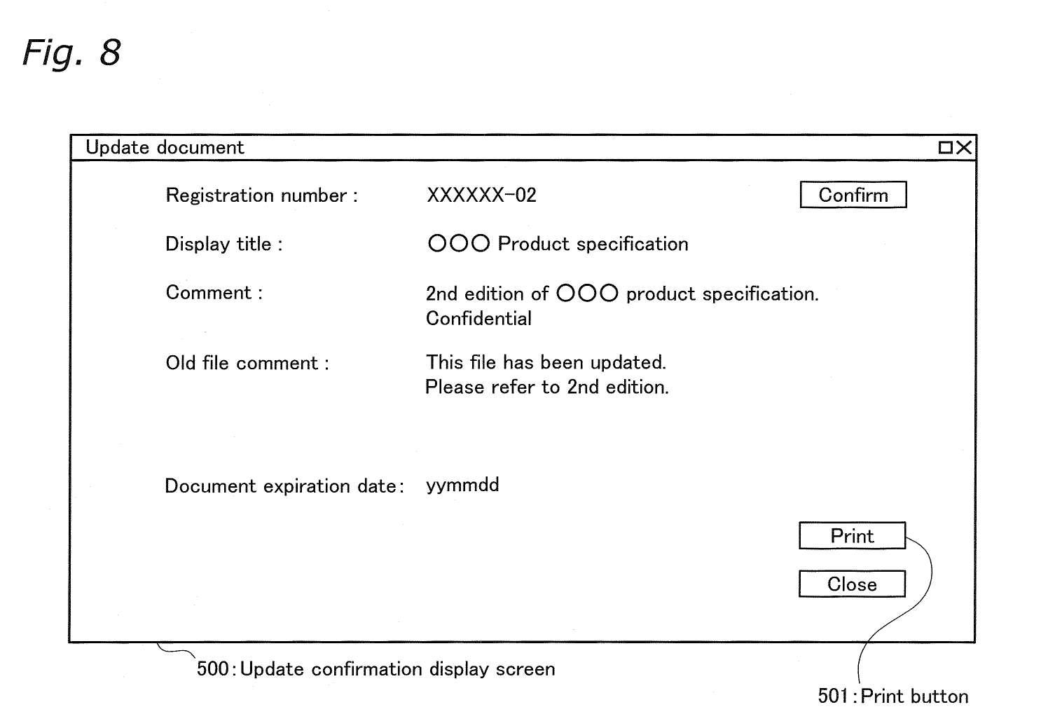

FIG. 7 illustrates an update operation display screen of the terminal 20 according to the first embodiment, and FIG. 8 illustrates an update confirmation display screen of the terminal 20 according to the first embodiment.

As shown in FIG. 7, an update display screen 400 is comprised of an update file selection portion 401, an update file input portion 402, a display file input portion 403, a comment input portion 404, an old file comment input portion 405, a expiration date input portion 406, a find button 407, an update button 408, and a close button 409.

If a revision to a document has been produced and the document file on the document management server 10 is to be updated, then the document file to be updated is selected with the update file selection portion 401 on the update input selection screen 400. In this example, registration number XXXXX-01 has been selected from a list. Note that only the most recently revised version of each document file is displayed here. Then, the update file, display title and comments are set with the same sequence described above for new document file registrations.

Then, changes to the comments attached to the previous version of the document file can be made with the old file comment input portion 405, and comments on the previous version of the document file will be overwritten with the comments input here. The content of the comments is extremely important for purposes of managing the document files, and appropriate comments such as “This file has been updated. Please refer to the second edition” will be input here. In addition, a sentence such as “This file has been updated” may be automatically inserted at the end of the comments.

When the update button 408 button is clicked, this content is registered in the document management server 10 and the suffix of the registration number for the document file will be updated to “-02” The updated registration number will be displayed in the update confirmation display screen 500. In this step, when the bar code 61 printed on the document 60 during new registration is read by the bar code reader 40, a comment such as “This file has been updated. Please refer to the second edition” will be displayed on the bar code reader 40. In other words, a person who attempts to use an earlier version of the document 60 can confirm that this document 60 is not the most recent version thereof by simply reading the bar code 61 on the document 60 with the bar code reader 40.

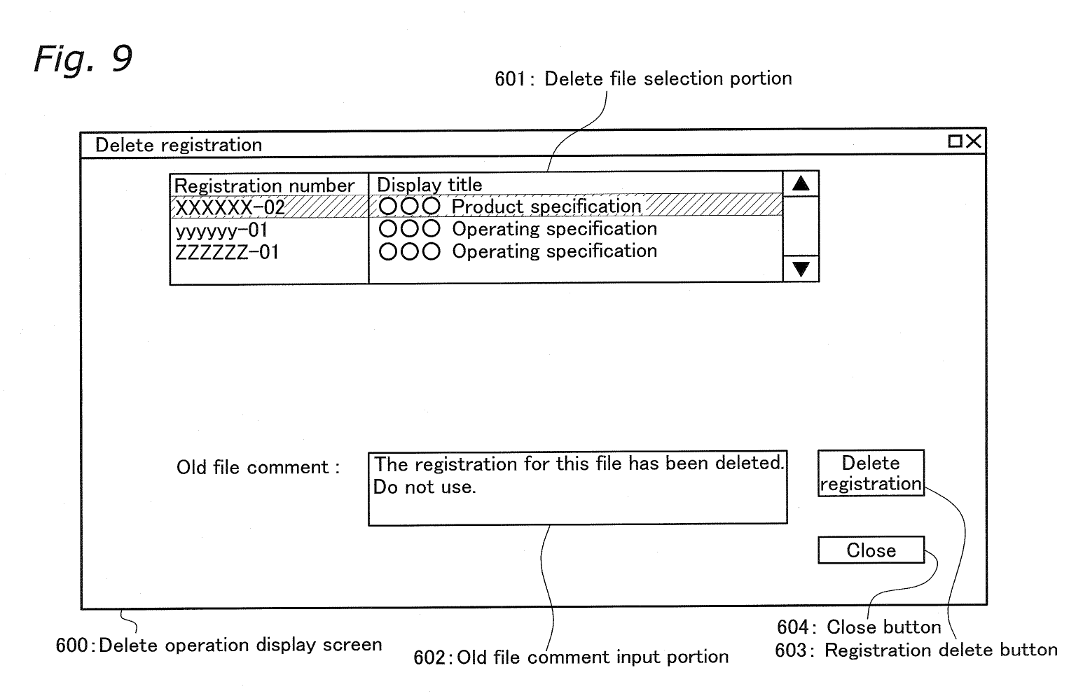

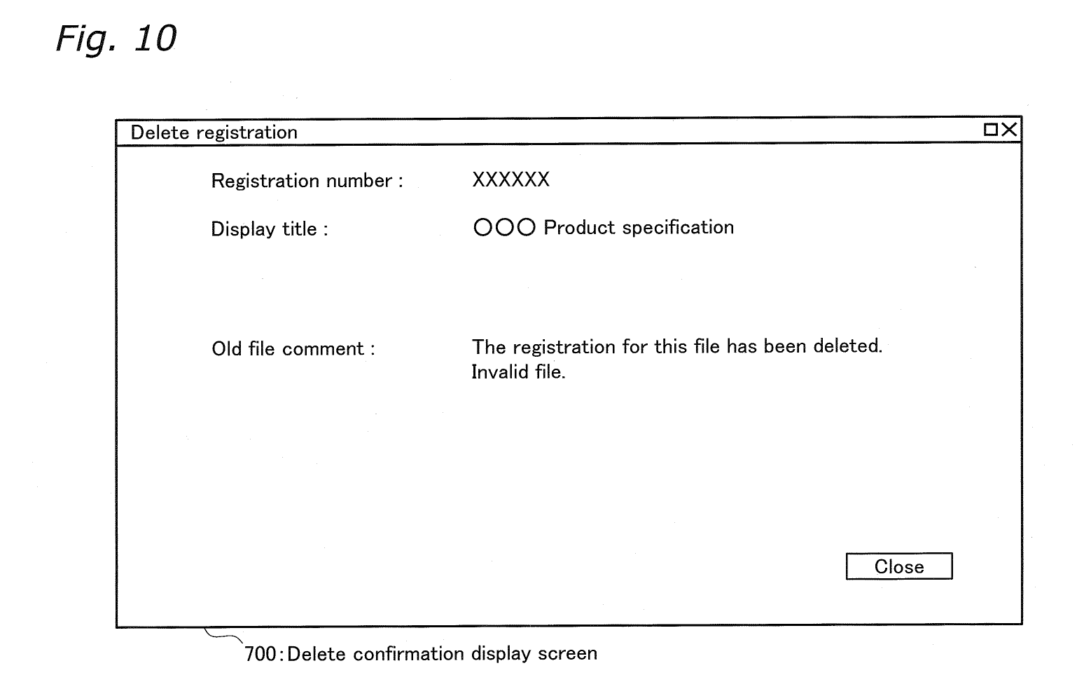

FIG. 9 illustrates a delete operation display screen of the terminal 20 according to the first embodiment, and FIG. 10 illustrates a delete confirmation display screed of the terminal 20 according to the first embodiment.

As shown in FIG. 9, a delete operation display screen 60 is comprised of a delete file selection portion 601, an old file comment input portion 602, a registration delete button 603, and a close button 604.

If a document file is to be deleted, the document file to be deleted is selected with the delete file selection portion 601 on the delete operation display screen 600, and a comment such as “The registration for this file has been deleted. Do not use.” is input in the old file comment input portion 602. In this example, this comment will be automatically applied because a document file having a “-02” suffix has been deleted, and will also be automatically applied to the previous versions of this document file having a “-01” suffix. In addition, a comment such as “The registration for this file has been deleted.” may be automatically inserted in the old file comment input section 602 when a document file is deleted.

When the registration delete button 603 is clicked, the delete confirmation display screen 700 shown in FIG. 10 will appear and the contents thereof can be confirmed. Then, when the bar code 61 of this document 60 is read with a bar code reader 40, a comment such as “The registration for this file has been deleted. Do not use.” will be displayed on the bar code reader 40. This prevents the deleted document 60 from being referenced.

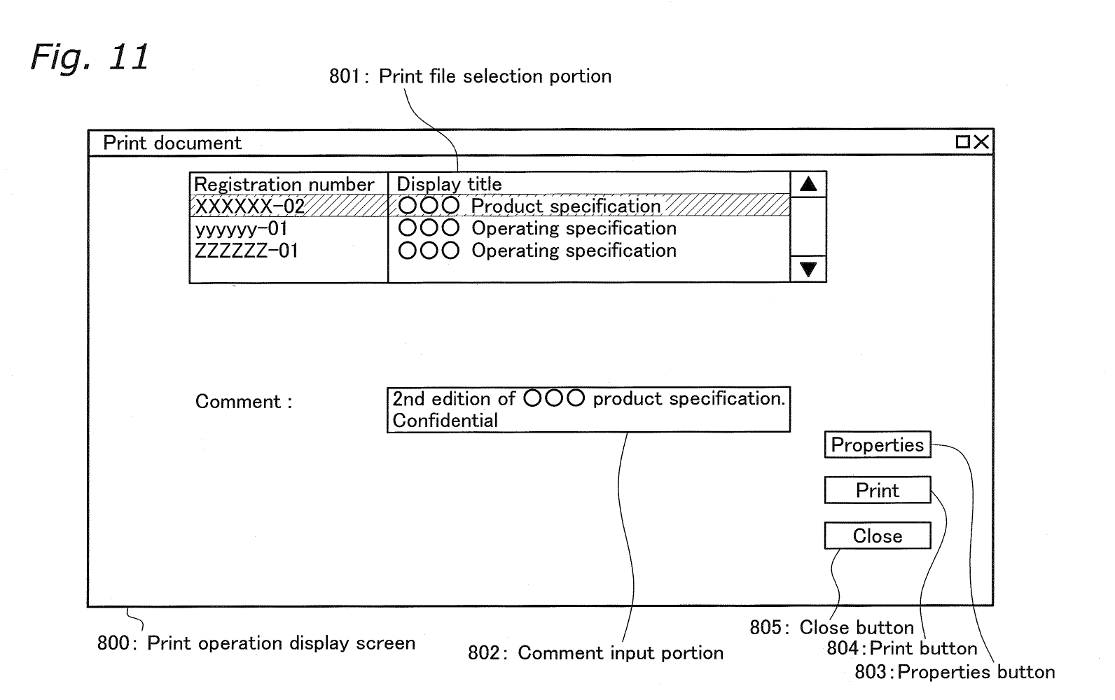

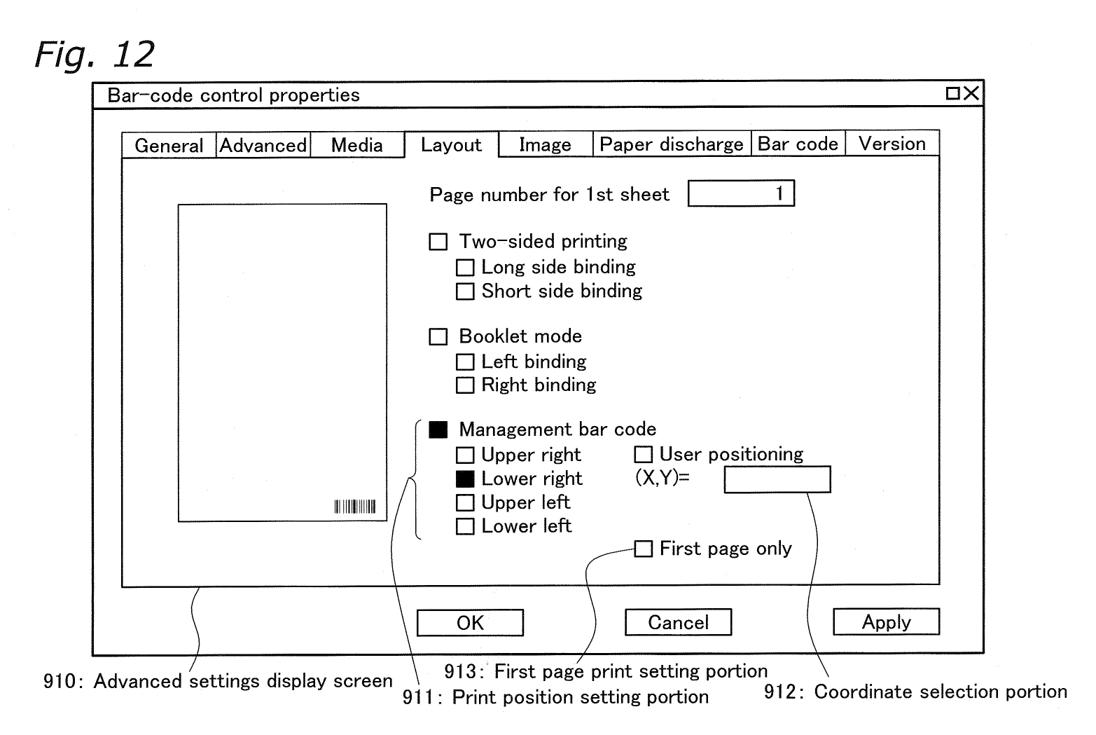

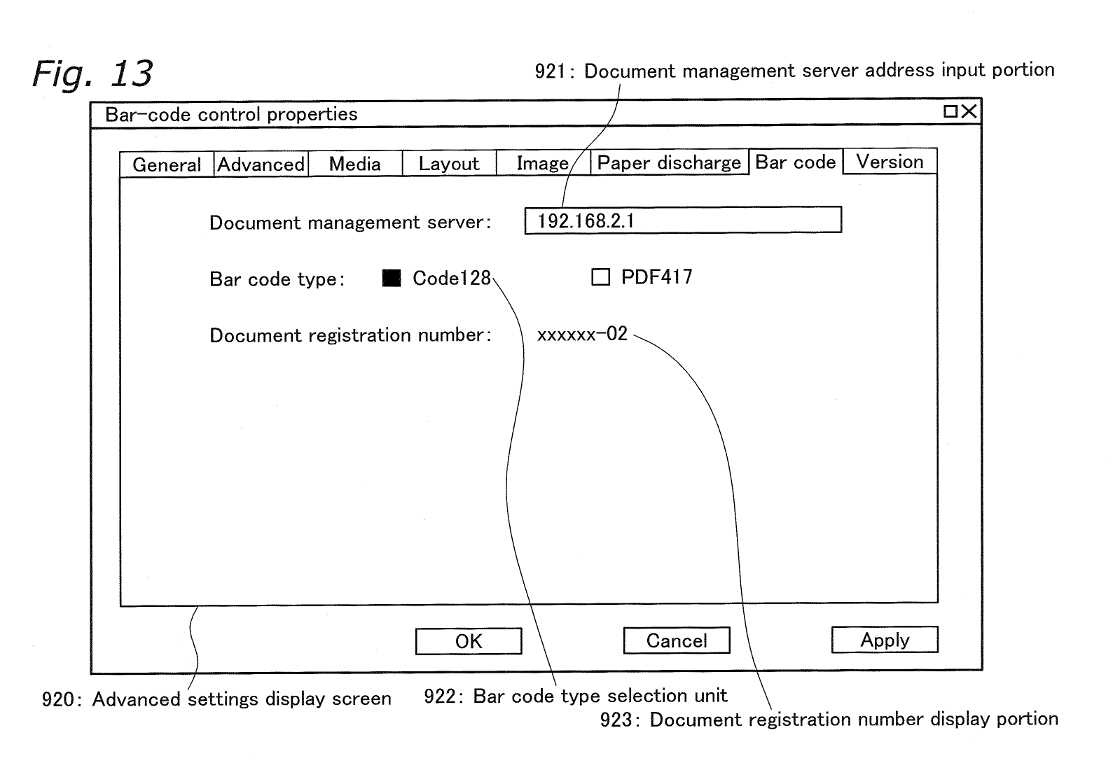

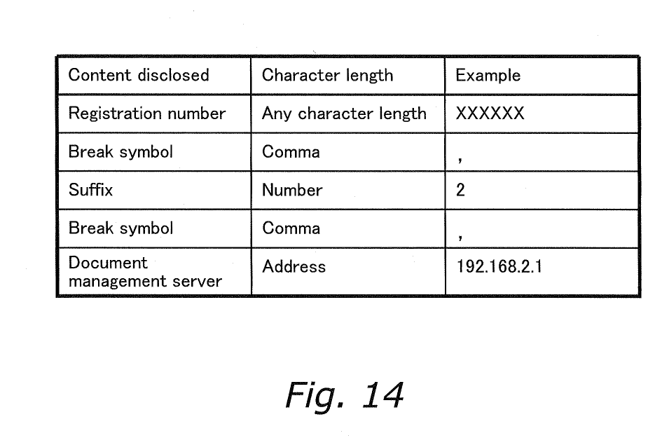

FIG. 11 illustrates a print operation display screen of the terminal 20 according to the first embodiment, FIG. 12 illustrates a print details setting screen (layout) of the terminal 20 according to the first embodiment, FIG. 13 illustrates a print details setting screen (bar code) of the terminal 20 according to the first embodiment, and FIG. 14 illustrates details of the bar code print setting according to the first embodiment.

When a managed document file is to be printed with a bar code thereon, the print button 302 on the new registration confirmation display screen 300 shown in FIG. 6 or the print button 501 on the update confirmation display screen 500 shown in FIG. 8 will be clicked on by the user, and a print operation display screen 800 and the print driver will be called up.

As shown in FIG. 11, the print operation display screen 800 is comprised of a print file selection portion 801, a comment input portion 802, a properties button 803, a print button 804, and a close button 805.

When one clicks on the properties button, one can proceed from the print operation display screen 800 to the advanced settings display screens 910, 920 shown in FIGS. 12 and 13. The advanced settings display screen 910 shown in FIG. 12 is a specialized driver layout settings page, and not only allows a user to change conventional layout settings, but also allows a user to set the print position of the bar code 61 with the print position setting portion 911. In this example, the layout is set such that the bar code 61 will be printed on the lower right side of the page. If it appears that the bar code 61 will be printed on top of text 62 of the document 60, then the bar code 61 can be printed on a blank portion of the document 60 by selecting the coordinates of the print position of the bar code with a coordinate selection portion 912. In addition, if a first page print setting portion 913 is clicked by the user, the bar code 61 can be printed on only the first page of a multi-page document.

The advanced settings display screen 920 shown in FIG. 13 is a settings page related to the type of bar code 61 to be used, and is comprised of a document management server address input portion 921, a bar code type selection unit 922, and a document registration number display portion 923.

The document registration number is the registration number of the document file selected for printing and is obtained from the document management server 10. However, it is displayed in the advanced settings display screen 920 for confirmation purposes.

The contents of the bar code 61 to be printed with the settings of the advanced settings display screen 920 is shown in FIG. 14. The bar code 61 contains the unique portion of the document registration number, the suffix value, and the address of the document management server 10. Commas are used as break symbols. The contents of the bar code 61 are introduced into the print data with a page description language command such as MZP1800,3370BARC23,n,‘xxxxxx,2,192.168.2.100’,30,30,2,4,6,8,2,4,6,8; in order to print a Code 128 bar code.

“MZP=b 1800, 3370” are the initial coordinates of the position in which the printer 30 will begin to write the bar code 61 in the lower right portion of the document 60. “BARC23” indicates that a Code 128 bar code will be printed, “n” indicates that the bar code 61 will not include a string of printed characters, and xxxxxx,2,192.168.2.100 indicates the content of the bar code 61. The remaining portion of the command indicates the size of the bar code 61 to be printed.

The printer 30 will print the bar code 61 when this command is inserted into the print data. Note that the type of bar code 61 to be printed is not particularly limited, and may be a two dimensional bar code such as a PDF471.

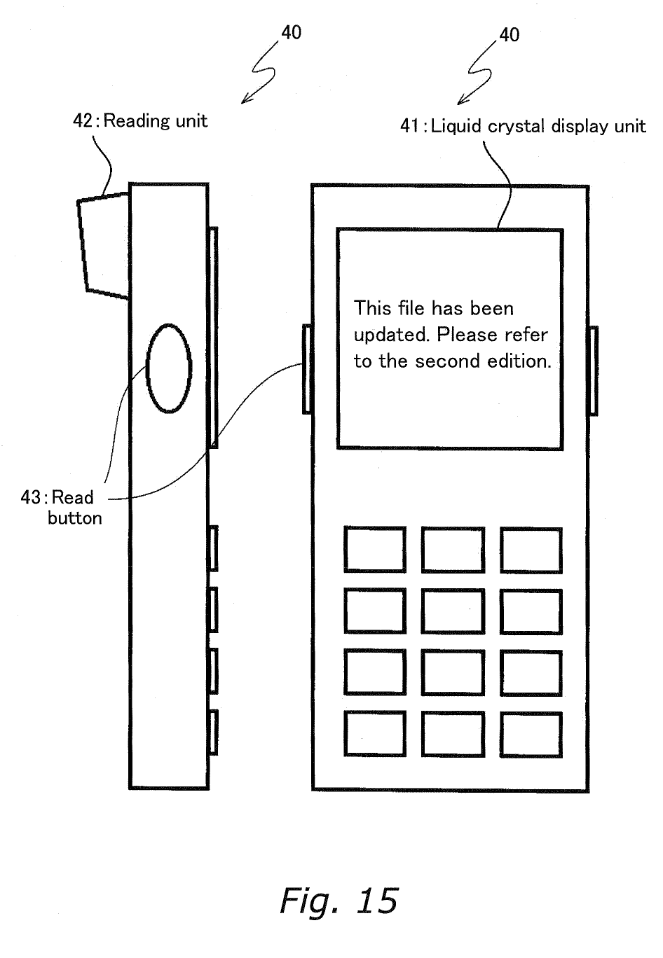

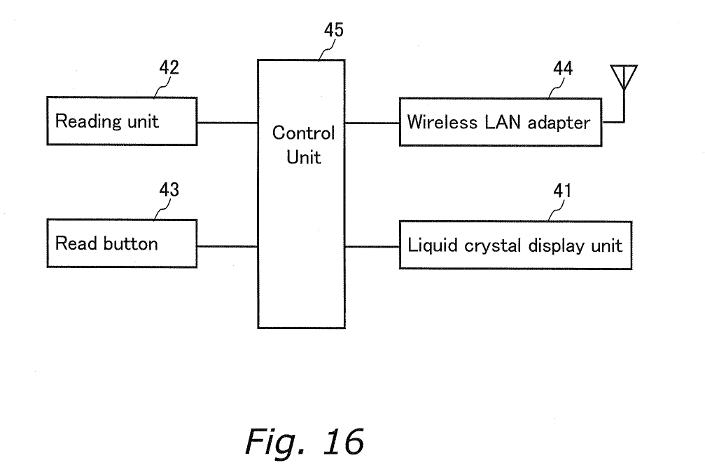

FIG. 15 shows lateral and front views of a bar code reader according to the first embodiment, and FIG. 16 is a block diagram illustrating the configuration of the bar code reader according to the first embodiment.

As shown in these figures, the bar code reader 40 is comprised of a liquid crystal display unit 41 that displays comments on document files, a reading unit 42 that reads the bar code 61 on a document 60, a read button 43 that initiates reading of a bar code 61, a wireless LAN adapter (wireless communication module) 44 that can be connected to the access point 51 via the network 50 (e.g., a wired LAN), and a control unit 45 that controls these elements.

The reading unit 42 can read the bar code 61 even from tens of centimeters away. After the read button 43 is pushed, the bar code 61 will be read and a sound that confirms that the bar code 61 has been read will be generated.

The wireless LAN adapter 44 and the control unit 45 access the network address of the document management server 10 (e.g., 192.168.2.100) in accordance with the information read from the bar code 61, and acquires the supplemental information for the registration number “xxxxxx-02”. The acquired comments are, for example, “This file has been updated. Please refer to the second edition.”, and are displayed on the display unit 41.

In other words, the control unit 45 acquires supplemental information on a document 60 from the document management server 10 in accordance with the information read from a bar code 61 on the document 60, and displays this supplemental information on the display unit 41.

The bar code reader 40 can employ a variety of different protocols when acquiring supplemental information from the document management server 10, however the bar code reader 40 may send a query to, for example, “http://192.168.2.100/xxxxxx/02” and receive comment data for managed document “xxxxxx-02” in HTML format.

In addition, the IP address of the document management server 10 is a private address in this example, but may also be a global address. For example, the address of the document management server 10 can be expressed as a URL, and provide supplemental information on a document 60 in a global environment such as the Internet.

According to the document management system of the first embodiment described above, a person who references a document 60 can easily acquire supplemental information such as comments that were made in response to the updating and/or deletion of the document 60 by simply reading the bar code 61 on the document 60 with the bar code reader 40.

This allows one to easily confirm the validity of the document 60 when referencing the same, and as a result, mistakes and losses caused by referencing an old version of the document 60 can be prevented.

In addition, when a managed document file is updated, the document management server 10 will allocate a new registration number to the document file, and request an update to the supplemental information associated with the registration number that was stored prior to the update. Thus, supplemental information on old document files can be updated and the reliability of the supplemental information can be improved.

Furthermore, when a managed document file is updated, the document management server 10 can automatically update stored supplemental information associated with a pre-update registration number, and thus when a document file is updated, not only will the supplemental information for the old document file be updated, but the task of updating the supplemental information will be eliminated.

In addition, when a managed document file is deleted, the document management server 10 will request an update to the stored supplemental information associated with the registration number. Thus, supplemental information on a document file can be updated when the document file is deleted, and the thus reliability of the supplemental information can be improved.

Furthermore, when a managed document file is deleted, the document management server 10 can automatically update stored supplemental information associated with that registration number, and thus, not only will the supplemental information for a document file be updated when the document file is deleted, but the task of updating the supplemental information will be eliminated.

In addition, the registration number allocated to a document 60 and the network address of the document management server 10 will be printed on the document 60 as a bar code 61, and thus the network address of the document management server 10 does not have to be input each time one wants to acquire supplemental information on a document 60, thereby allowing the supplemental information to be rapidly acquired.

Furthermore, the supplemental information acquisition device is the bar code reader 40 comprised of the wireless LAN adapter 44, and thus the bar code reader 40 can be used to acquire supplemental information on documents 60 in a variety of locations.

Note that the present invention is not limited to the aforementioned embodiment. For example, the document management server saves managed documents and provides supplemental information in the aforementioned embodiment, however these functions may be performed by separate servers.

In addition, document management terminal software is loaded in the terminal 20 in the aforementioned embodiment, however a browser can be employed on the terminal 20 to perform the same type of document management that the document management terminal software performs if a web page that allows the same functions to be executed is provided by the document management server.

Furthermore, documents are managed in the aforementioned embodiment, however a variety of different types of written material can be managed, such as specifications, drawings, process documents, application forms, certificates, advertisements, catalogs, price lists, name lists, telephone books, address books, technical documents, publications, and the like. In addition, the supplemental information to be provided may include update information, use history information, expiration date information, error information, up-to-date citation information, link information, and the like.

For example, an official document issued by a governmental authority is typically valid for a certain period of time after it is issued. However, the system of the present invention can be used to confirm whether or not the official document is the most up-to-date version thereof. Thus, it will not no longer be necessary for official documents to be valid for only a limited period of time, and this can contribute to an improvement in government service.

Furthermore, if the system of the present invention is used to manage supplemental information for a book or a magazine, the supplemental information acquisition device can be used to acquire a list of errors that were discovered after publication of the book or magazine.

In addition, if the system of the present invention is adapted for use with advertisements, it can be used to acquire information on openings in tours, hotels, and the like, or link information such as the number of tickets remaining for an event, by simply reading identification information on the advertisement.

Furthermore, if the system of the present invention is used to manage technical documents or the like, the most recent citations that are cited in a technical document can be easily acquired as supplemental information.

In addition, the supplemental information acquisition device is not limited to the aforementioned bar code reader.

### 2. Second Embodiment

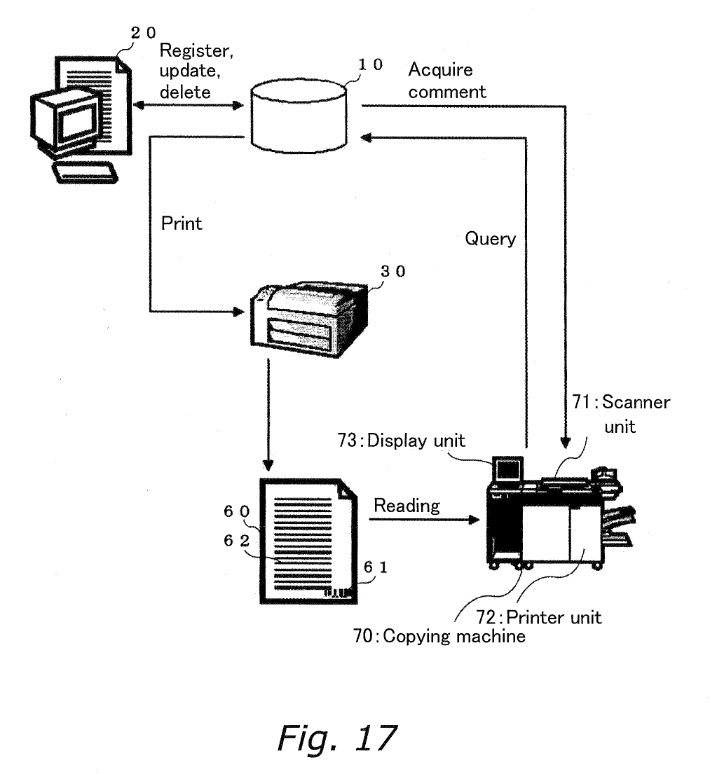

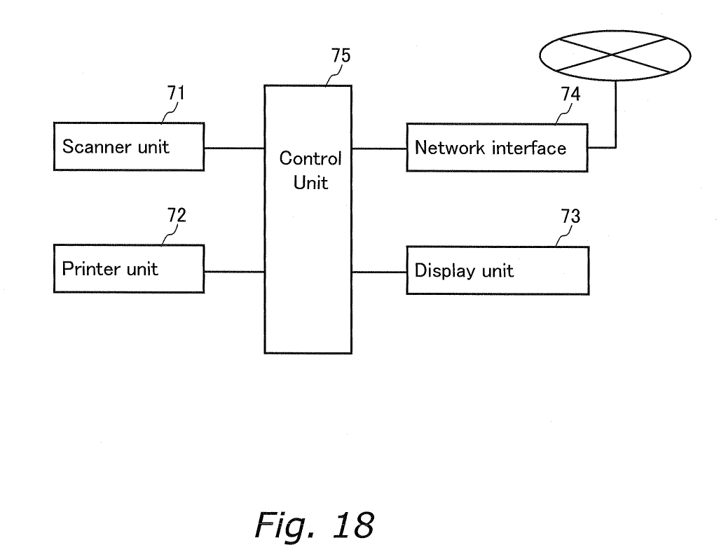

FIG. 17 illustrates the configuration and use of a document management system according to a second embodiment of the present invention, and FIG. 18 is a block diagram illustrating the configuration of a copying machine of the second embodiment.

As shown in these figures, the document management system of the second embodiment differs from that of the first embodiment in that the supplemental information acquisition device is comprised of a copying machine 70. The copying machine 70 is comprised of a scanner unit 71 that reads original documents, a printer unit 72 that conducts printing based upon data read from original documents, a display unit 73 that displays the setting state of the copying machine 70, a network interface 74 that can be connected to the network 50, and a control unit 75 that controls these elements.

The configuration of these elements is approximately the same as that of a conventional copying machine, however the copying machine 70 can be made to function as a supplementary information acquisition device by loading into the control unit 75 software that extracts a bar code 61 from image data on a document 60 read by the scanner unit 71 from, and software that acquires supplemental information on the document 60 from the document management server 10 based upon identification information that is included in the bar code 61 and displays this supplemental information on the display unit 73.

For example, when a copy is to be made with the copying machine 70, the copying machine 70 continuously monitors the image data read by the scanner unit 71 to determine whether or not the image data includes a bar code 61. If a bar code 61 is detected by the copying machine 70, the copying machine 70 will acquire supplemental information for a document 60 from the document management server 10 based upon identification information included in the bar code 61, and display this supplemental information on the display unit 73.

A comment identical to that described in the first embodiment, such as “This file has been updated. Please refer to the second edition.” may be the supplemental information displayed, or may be a comment related to the copying machine 70, such as “Copying prohibited!”.

In addition, in situations in which the copying machine 70 is also used as a supplemental information acquisition device, the comment may be converted to sound and transmitted to a user making copies because the user may fail to see the supplemental information displayed.

According to the second embodiment described above, a dedicated supplemental information acquisition device need not be employed, and the copying machine 70 may be used to acquire supplemental information on a document 60. In addition, if the document management system of the second embodiment is configured such that supplemental information is automatically confirmed when a document 60 is copied, one can be prevented from making copies of old versions of the document 60.

### 3. Third Embodiment

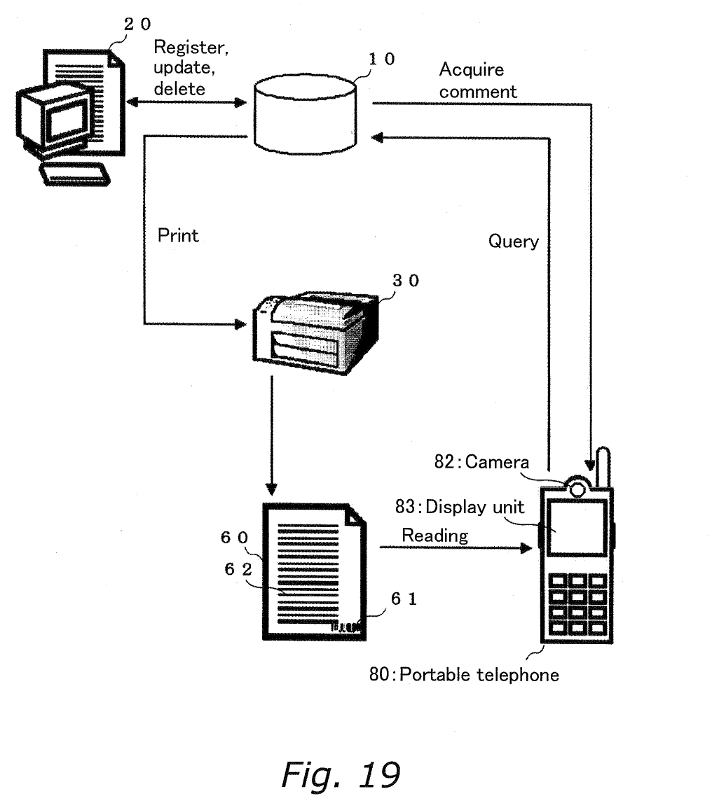

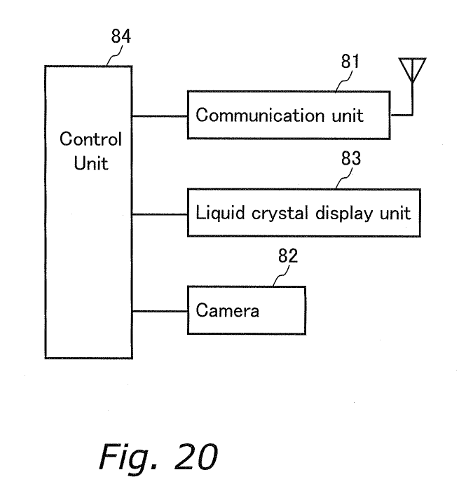

FIG. 19 illustrates the configuration and use of a document management system according to a third embodiment of the present invention, and FIG. 20 is a block diagram illustrating the configuration of a portable telephone of the third embodiment.

As shown in these figures, the document management system of the third embodiment differs from that of the first and second embodiments in that the supplemental information acquisition device is comprised of a portable (cellular) telephone 80. The portable telephone 80 is comprised of a communication unit 81 that can connect to the network 50 via a base station, a camera 82 that is comprised of a CCD or the like, a display unit 83 that displays images or the like photographed by the camera 82, and a control unit 84 that controls these elements.

The configuration of these elements is approximately the same as that of a conventional portable telephone, however the portable telephone 80 can be made to function as a supplementary information acquisition device by loading into the control unit 84 software that extracts a bar code 61 from image data on a document 60 photographed by the camera 82, and software that acquires supplemental information on the document 60 from the document management server 10 based upon identification information that is included in the bar code 61 and displays this supplemental information on the display unit 83.

According to the third embodiment described above, a dedicated supplemental information acquisition device need not be employed, and the portable telephone 80 may be used to acquire supplemental information on a document 60. In addition, the portability of the portable telephone 80 can be used to acquire supplemental information on documents 60 at a variety of locations.

As noted above, the present invention allows one who references and/or uses a document to easily acquire supplemental information on that document that is updated in response to changes in the document by employing the supplemental information acquisition device. This allows one to easily confirm the validity of documents when referencing and/or using the same, and as a result, mistakes and losses caused by referencing and/or using old versions of documents can be prevented.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. A supplemental information dissemination system that provides supplemental information on managed documents having unique identifying information printed thereon, the supplemental information dissemination system comprising:
a supplemental information management server that stores supplemental information on each document having identifying information associated with each document; and
a supplemental information acquisition device that reads identifying information for a document, and acquires stored supplemental information on the document associated with the identifying information from the supplemental information management server.

2. The supplemental information dissemination system set forth in claim 1, wherein the supplemental information management server and the supplemental information acquisition device are connected to each other via a network.

3. The supplemental information dissemination system set forth in claim 2, further comprising a print device that both prints documents and prints encoded identifying information on the documents.

4. The supplemental information dissemination system set forth in claim 1, wherein when the contents of managed documents have been updated, the supplemental information management server will both allocate new identifying information to updated documents, and request or allow updates to stored supplemental information associated with pre-update identifying information.

5. The supplemental information dissemination system set forth in claim 1, wherein when the contents of managed documents have been updated, the supplemental information management server will both allocate new identifying information to updated documents, and automatically update stored supplemental information associated with pre-update identifying information.

6. The supplemental information dissemination system set forth in claim 1, wherein when a managed document has been deleted, the supplemental information management server will request or allow the stored supplemental information associated with identifying information for the deleted document to be updated.

7. The supplemental information dissemination system set forth in claim 1, wherein when a managed document has been deleted, the supplemental information management server will automatically update the stored supplemental information associated with identifying information for the deleted document.

8. The supplemental information dissemination system set forth in claim 3, wherein the print device prints encoded identifying information allocated to a document, an encoded network address of the supplementary information management server, and encoded information on the location of the supplementary information on the document.

9. The supplemental information dissemination system set forth in claim 3, wherein the print device will print the identifying information as a bar code.

10. The supplemental information dissemination system set forth in claim 1, wherein the supplemental information acquisition device comprises a reading unit that reads the identifying information printed on a document, and a display unit that presents supplemental information based upon the identifying information read by the reading unit and acquired from the supplemental information management server to a user in the form of text or sound.

11. The supplemental information dissemination system set forth in claim 1, wherein the supplemental information acquisition device is a bar code reader comprised of a wireless communication module.

12. The supplemental information dissemination system set forth in claim 1, wherein the supplemental information acquisition device is a copying machine comprised of a network interface and a scanner, and extracts encoded identifying information from document image data read by the scanner.

13. The supplemental information dissemination system set forth in claim 1, wherein the supplemental information acquisition device is a portable telephone comprised of a camera, and extracts encoded identifying information from document image data photographed by the camera.
